(19) United States
(12) Patent Application Publication
(10) Pub. No.: US 2015/0280786 A1
(43) Pub. Date: Oct. 1, 2015

(54) NEAR FIELD COMMUNICATION BASED DATA TRANSFER

(71) Applicant: RAVEESHKUMAR BHAT, BANGALORE (IN)

(72) Inventor: RAVEESHKUMAR BHAT, BANGALORE (IN)

(21) Appl. No.: 14/230,247

(22) Filed: Mar. 31, 2014

(51) Int. Cl. H04B 5/00

(52) U.S. Cl. CPC H04B 5/0031

(57) ABSTRACT

A near field communication (NFC) tag is programmed to execute a NFC tag based data transfer. The NFC tag may receive a device-tap from an NFC enabled device. Upon receiving the device-tap, the NFC tag initiates a communication with an associated server. The NFC tag authenticates the NFC enabled device with the associated server, and determines notifications available at the server. The NFC tag fetches a plurality of notifications corresponding to the authenticated NFC enabled device from the server and forwards the notifications to the NFC enabled device.

The NFC tag may monitor the server by monitoring a status of the notifications available at the server, to identify a modification or a latest version of the notification. Upon encountering a modification or a latest version, within a configured timeframe, the NFC tag overwrites its contents to match the modification or latest version of the notification.

### BACKGROUND

Workforce management encompasses different employee services that assist in maintaining a productive workforce. Employee services may include: employee leave request services, employee self-services, employee performance management services, etc. Currently, in a typical company, work force management related services are provided at a central server that stores the employee data, such as, number of leaves remaining for an employee, number of hours spent on a particular project, etc.

An employee can accesses these services by logging to the company's network and then accessing the central server. Typically, the employee may be using several of these services within a workday, for example, applying for a leave, supplying time spent on a particular project, checking salary information, etc. Content related to these services may be altered over time. Logging to the company's network every time the user wants to access any of these services and/or check for any alterations therein—may be cumbersome and time-consuming.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system to execute a near field communication (NFC) tag based data transfer, according to an embodiment.

FIG. 2 is a flow diagram illustrating a process to execute a near field communication (NFC) tag based data transfer, according to an embodiment.

FIG. 3 is a sequence diagram illustrating an execution of a near field communication (NFC) tag based data transfer, according to an embodiment.

FIG. 4 is a flow diagram illustrating a process to execute a near field communication (NFC) tag based data transfer, according to an embodiment.

FIG. 5 is a block diagram illustrating an exemplary computer system, according to an embodiment.

### DETAILED DESCRIPTION

Embodiments of techniques to execute a near field communication (NFC) tag based data transfer are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

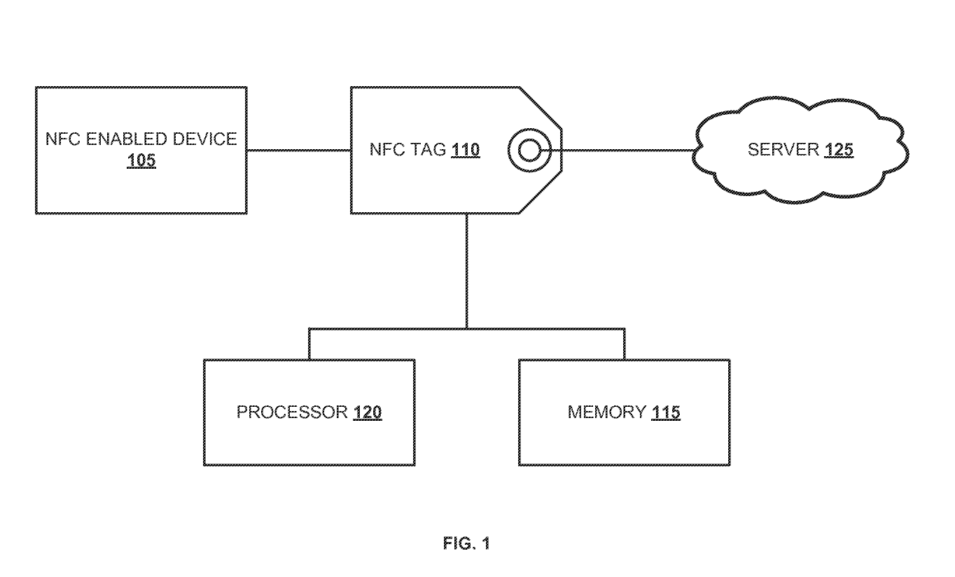

FIG. 1 is a block diagram illustrating a system to execute a near field communication (NFC) tag based data transfer, according to an embodiment. Near field communication (NFC) is a set of standards to establish radio communication between two devices which are in direct contact or within a predetermined range, for example, 10 centimeters, from each other. Contactless transactions, data transfers, and many other communications are possible using NFCs. Generally, communications using NFC may be established between NFC enabled devices and a NFC chip, also known as a ‘tag’. NFC tag 110 may be a device, for example, a sticker or a wristband, which includes a data transfer integrated circuit (IC). The data transfer IC of NFC tag 110 controls data transfer by the NFC tag 110. NFC enabled device 105 may be a handheld electronic device, for example, mobile phone, tablet computer, laptop, personal digital assistant, etc., NFC enabled device 105 may be a NFC enabled portable electronic device that may establish NFC communication with NFC tag 110. NFC enabled device 105 may include a data transmitter-receiver module for writing data to NFC tag 110 and receiving data from NFC tag 110.

NFC tag 110 may be programmed to facilitate data transfer between NFC enabled device 105 and server 125. Server 125 may stores and processes data. In an embodiment, server 125 may be provided in a cloud. Cloud computing addresses a variety of computing concepts that involve a large number of computers connected through a real-time communication network such as the Internet.

NFC tag 110 may be programmed to execute a NFC based data transfer. Programming NFC tag 110 may include writing a data transfer program to the data transfer IC of NFC tag 110. The data transfer program defines a sequence of data transfer steps for two-way communication between NFC enabled device 105 and NFC tag 110. The data transfer program may include: detecting a device-tap from NFC enabled device 105, establishing a communication between NFC tag 110 and server 125, authenticating NFC enabled device 105, detecting data and/or notifications availability at server 125, fetching data and/or notifications corresponding to NFC enabled device 105, persisting the fetched data and/or notifications, forwarding the data and/or notifications to NFC enabled device, and the like. Memory 115 may store the data fetched from server 125. Processor 120 may be in communication with the data transfer IC to process the data transfer program written in NFC tag 110. NFC tag 110 may also be reprogrammed to execute a NFC based data transfer by overwriting a current program residing in NFC tag. The reprogrammed NFC tag 110 may fetch a latest version of data and/or notifications, deploy NFC tag 110 by overwriting the contents of NFC tag 110 with a latest version of data and/or notification.

Several computing applications may use the “data transfer” program, written to the data transfer IC of NFC tag 110. The applications may use the data transfer program to perform application data transfer between NFC enabled device 105 and server 125, at runtime. An application or an “app” is computer software that when executed performs a useful task. The applications may also be written to the data transfer IC included in NFC tag 110. The applications may be included in the data transfer program written to the data transfer IC of NFC tag 110. Alternatively, the application may be a stand-alone application written to the data transfer IC of NFC tag 110. NFC tag 110 may allow a user of NFC enabled device 105 to access and update application data to server 125, without requiring the user of NFC enabled device 105 to login to server 125. Specifically, the data transfer steps included in the data transfer program written to NFC tag 110 allows application data transfer between NFC enabled device 105 and server 125, without requiring the user to login to server 125. The programmed NFC tag 110, including the data transfer program, may be used by any number of applications that require one-way or two-way communication between NFC enabled device 105 an (server 125 to transfer application data.

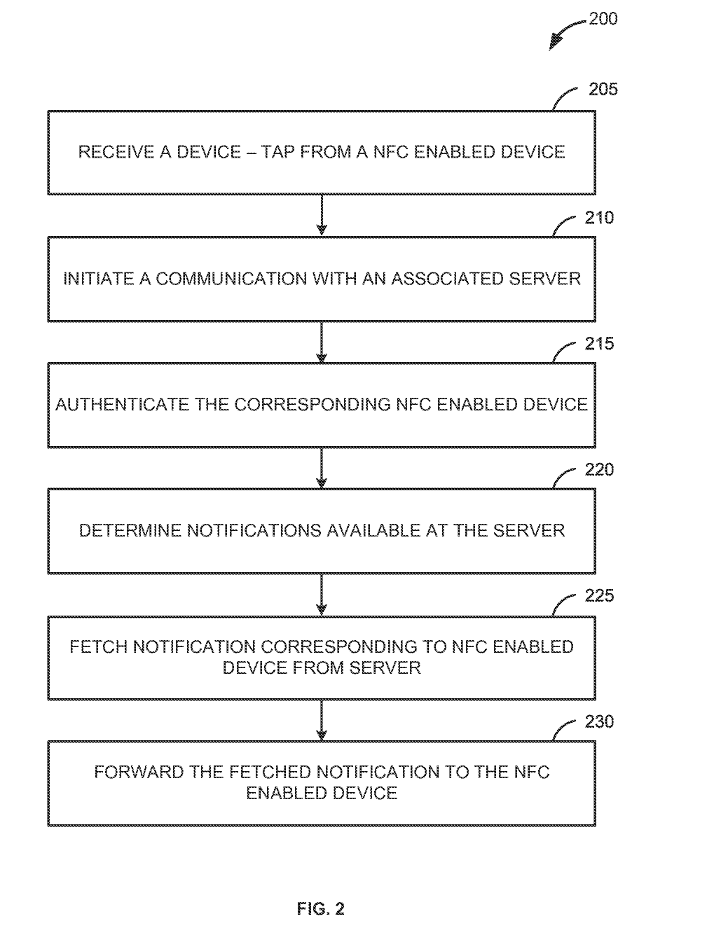

FIG. 2 is a flow diagram illustrating a process to execute a near field communication (NFC) tag based data transfer, according to an embodiment. The data transfer process may outline data-transfer steps for transferring data between two devices, for instance, between NFC enabled device 105 and server 125. Enabling notifications present in server 125 and pushing the enabled notifications from server 125 to NFC enabled device 105 may be executed by the programmed NFC tag (e.g. 110).

In an embodiment, the data transfer process 200 includes configuring NFC tag 110 to receive a device-tap from NFC enabled device 105. A device-tap may represent bringing NFC enabled device 105 in contact with or proximity to NFC tag 110. For example, using access-cards to gain physical access to a building. Here the access-card is brought close to or is placed in contact with a card-reader which reads programs embedded in the card to authenticate the access request and grant access, e.g. by opening a door of the building. In a similar manner, NFC enabled device 105 may be tapped on a reader that houses NFC tag 110. Thus, at 205, NFC tag 110 receives a device-tap front NFC enabled device 105.

At 210, upon receiving the device-tap from NFC enabled device 105, NFC tag 110 initiates a communication with associated server 125. At 215, corresponding NFC enabled device 105 that established a device-tap is authenticated. Authenticating the device includes determining if device 105 is registered as NFC enabled device for server 125. Authenticating the device includes permitting the device to carry out authenticated data transfers. For the registered NFC enabled devices, any data transfer between the corresponding devices and server 125 is permitted to occur. Once the authentication is executed, NFC tag 110 (and/or data transfer IC), at 220, determines a plurality of notifications available at server 125. In an embodiment, server 125 is queried to determine the plurality of notifications available for corresponding authenticated devices. NFC tag 110 (and/or data transfer IC) also determines a relevance of the notifications with corresponding NFC enabled and authenticated devices. The relevance is determined to identify appropriate notifications to the corresponding devices. For e.g. consider three devices NFC device 1, NFC device 2 and NFC device 3 that are authenticated to receive notifications from server 125. When the devices are tapped to NFC tag 110, NFC tag 110 authenticates the devices, determines available notifications, and determines the relevancy of notifications to identify which notification to be sent to which device.

At 225, NFC tag 110 fetches the notifications corresponding to NFC enabled device 105 along with the relevancies from server 125. Fetching the notifications includes extracting (or pulling) of data to be transferred from server 125 to NFC enabled device 105, along with a notification conveying a presence of such data to be transmitted to NFC enabled device 105, and an address or a relevancy of the device to receive the corresponding data. In an embodiment, the fetched notifications are persisted and stored in memory 115 associated with NFC tag 110. Upon receiving a device-tap from an authenticated device, at 230, NFC tag 110 forwards or pushes the persisted notification fetched from server 125 to NFC enabled device 105.

In an embodiment, NFC enabled device 105 may receive modifications to the notifications transferred by NFC tag 110. Upon receiving a device-tap of such a device that has received modifications to the notifications, NED tag 110 fetches the modified notifications from NFC enabled device 105, establishes a communication with server 125 and forwards the modified notifications to server 125.

In an embodiment, NFC tag 110 is operable to monitor a status of notifications available at server 125. Monitoring the status of the notifications includes keeping a record of the status of the notifications, including: no-change status, modified status, deleted status, latest version available status, and the like. When a latest version of the notifications is encountered within a configured timeframe, NFC tag 110 overwrites its contents to match the latest version of the notifications. For example, consider a notification XYZ_SALES ORDER_{—}2014_JANUARY present in server 125 on 31 Jan. 2014. A configured timeframe for the sales order is forty-eight hours. If the notification may be modified to XYZ_SALES ORDER_{—}2014_FEBRUARY on 1 Feb. 2014, NFC tag 110 identifies the latest version available in forty-eight hours and overwrites existing contents of the notification in NFC tag 110 to match the latest version of the notification.

In an embodiment, when a change of status of the notifications is encountered by NFC tag 110, NFC tag 110 determines the modified notifications and revises its contents to match the modified notifications. Upon revising the contents, NFC tag 110 sets a flag to represent the revision of the contents, and the timeframe at which the revision occurred. For example, if contents of the notification XYZ_SALES ORDER_{—}2014_FEBRUARY is modified at 8:00 on 1 Feb. 2014, NFC tag 110 sets a flag to represent the revision, and a configured timeframe forty-eight hours along with the instance 8:00 1 Feb. 2014 at which the revision occurred. The flag may indicate a revision of notifications at NFC tag 110. By setting the flag, NFC tag 110 conveys a message of the revision/overwriting of notification present in NFC tag 110.

In an embodiment, when no change of status and/or no modifications are encountered by NFC tag 110 within the configured timeframe, NFC tag 110 schedules a status-check at a subsequent instance. NFC tag 110 resets the flag to represent or convey a message of no-change status of contents of NFC tag 110. For instance, if there is no modification of contents of the notification XYZ_SALES ORDER_{—}2014_JANUARY within forty-eight hours (configured) timeframe, NFC tag 110 may schedule a status-check at twenty-four hours subsequent to the forty-eight hour timeframe. At the end of the twenty-four hours, NFC tag 110 may perform a status-check to determine if any changes/modifications have occurred.

In an embodiment, NFC enabled devices (e.g. 105) may have subscribed to certain notifications from server 125. Once the authentication is executed, NFC tag 110 determines availability of notifications to which NFC enabled device 105 has subscribed, at server 125. NFC tag 110 fetches the subscribed notifications from server 125 and forwards the notifications to NFC enabled device 105. By subscribing to certain notifications, NFC enabled device 105 selects application data and/or notifications that are receivable on NFC enabled device 105. For instance, a user of NFC enabled device 105 selects “PERFORMANCE APPLICATION” out of various other applications, and subscribes to receive all notifications related to “PERFORMANCE APPLICATION”. By doing so, NFC enabled device 105 is notified only when notifications related to “PERFORMANCE APPLICATION” is available on server 125. NFC tag 110 fetches only the notifications related to “PERFORMANCE APPLICATION” from server 125 and forwards the notifications to NFC enabled device 105.

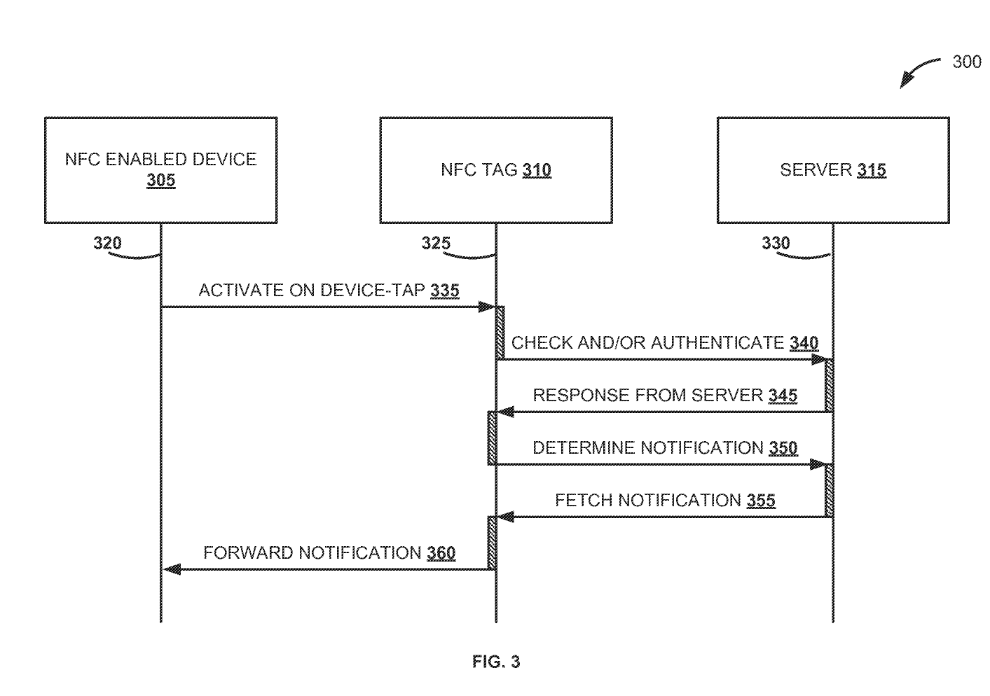

FIG. 3 is a sequence diagram illustrating an execution of a near field communication (NFC) tag based data transfer, according to an embodiment. Element 300 represents the interactions and the operations involved in the execution of a near field communication (NFC) tag based data transfer. Element 300 includes process objects NFC enabled device 305, NFC tag 310, server 315, along with their respective vertical lines originating from them. The vertical lines 320, 325 and 330 of NFC enabled device 305, NFC tag 310 and server 315 represent various processes involved in the execution of NFC tag based data transfer. The horizontal arrows (for example, 335, 340, 345, 350, 355, and 360) represent the data flow between the vertical lines originating from their respective process objects (for example, 305, 310 and 315). Activation boxes between the horizontal arrows represent the process that is being performed at the respective process object.

Upon receiving a device-tap from NFC enabled device 305, NFC tag 310 is activated. Horizontal arrow at the end of 335 represents a receiving of device-tap from NFC enabled device 305. Upon receiving the device-tap, NFC tag 310 initiates a communication with server 315 to authenticate NFC enabled device 305. Horizontal arrow 340 represents the process of initiating a communication with server 315. Activation box at the end of 340 represents a process of authentication of NFC enabled device 305. As a response to the authentication process, server responds to NFC tag 310, authenticating device 305. If NFC enabled device 305 is not a registered device with server 315, response from the server may be a denial of the authenticity of NFC enabled device 305. Horizontal arrow 345 represents the response from server 315. Activation box at the end of 345 represents a process of communication the response from server 315, to prepare NFC tag 310 for subsequent operations. For instance, NFC tag 310 prepares to determine notifications present in server 315. Horizontal arrow 350 represents the process of determining the notifications present in server 315. Activation box at the end of 350 represents the determination process. Determination process may include determining the notifications available in server 315, determining relevancies of the notification with corresponding NFC enabled device 305, to determine an address or a relevancy of NFC enabled device 305 to receive the corresponding data.

Upon determining the notification and associated data along with its relevancy, NFC tag 310 fetches the notification and the associated data pertaining to NFC enabled device 305. Horizontal arrow 355 represents the fetching of notification from server 315. Activation box at the end of 355 represents persisting of the fetched notifications along with its relevancies. In an embodiment, NFC tag 310 may map the notifications and associated contents to appropriate devices. Activation box at the end of 355 may represent the mapping operation that is executed at NFC tag 310. The notifications are forwarded to NFC enabled device 305, based upon their relevancies. The forwarding of notifications is represented by horizontal arrow 360.

In an embodiment, NFC tag 310 may monitor server 315 by monitoring a status of the notifications available at server 315, to identify a modification or a latest version of the notification. Horizontal arrow 350 may include a task of monitoring server 315. Upon encountering a modification or a latest version, within a configured timeframe, NFC tag determines the modification or the latest version and overwrites its contents to match the modification or latest version of the notification. Horizontal arrow 355 may include a task of determining the modification or the latest version. Activation box at the end of 355 may include overwriting NFC tag's contents to match the modification or latest version of the notification.

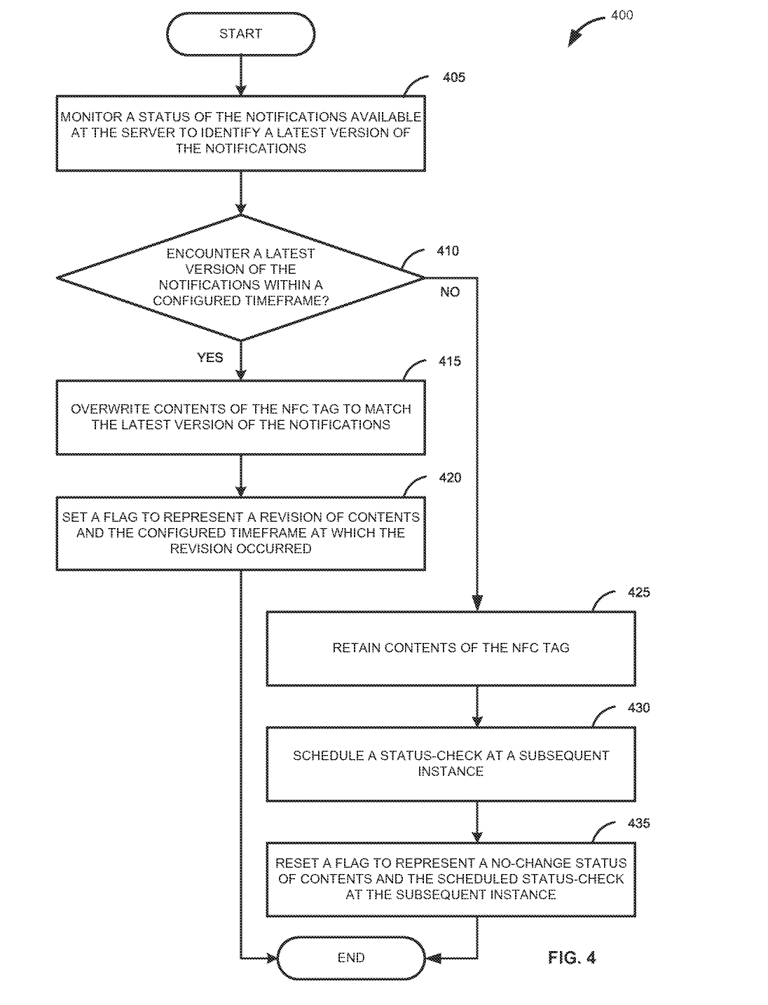

FIG. 4 is a flow diagram illustrating process to execute a near field communication (NFC) tag based data transfer, according to an embodiment. The data transfer process may outline data-transfer steps for transferring data between two devices, for instance, between an NFC enabled device and the server. In an embodiment, enabling notifications present in the server and pushing the enabled notifications from the server to the NFC enabled device are executed by the programmed NFC tag.

At 405, the NFC tag monitors a status of the notifications available at the server, to identify a latest version (and/or modifications) of the notification. At 410, an encounter of a latest version of the notification within a configured timeframe is determined. If there is an encounter of a latest version of the notification within the configured timeframe, the process proceeds to 415, where the contents of the NFC tag is overwritten to match the latest version of the notification. At 420, a flag is set to represent an execution of a revision of contents (by overwriting the contents), and the configured timeframe at which the revision occurred.

If there is no encounter of a latest version of the notification within the configured timeframe, the process proceeds to 425, where the contents of the NFC tag are retained. At 430, a status-check is scheduled at a subsequent instance. At 435, a flag is reset, to represent a no-change status of contents of the NFC tag and the scheduled status-check at the subsequent instance.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

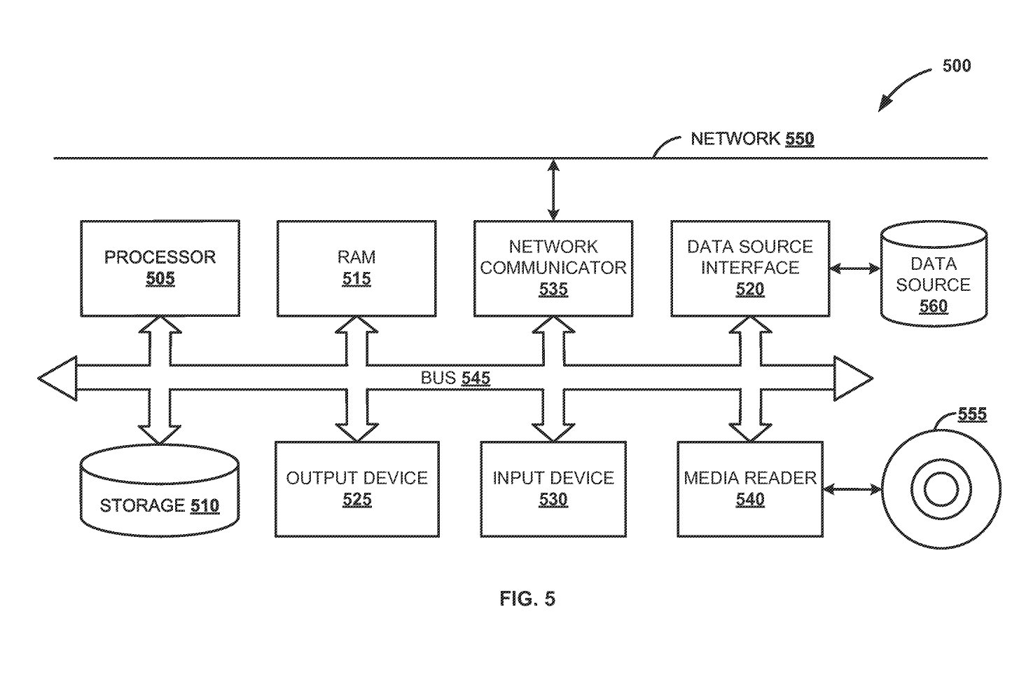

FIG. 5 is a block diagram of an exemplary computer system 500, according to an embodiment. The computer system 500 includes a processor 505 that executes software instructions or code stored on a computer readable storage medium 555 to perform the above-illustrated methods. The processor 505 can include a plurality of cores. The computer system 500 includes a media reader 540 to read the instructions from the computer readable storage medium 555 and store the instructions in storage 510 or in random access memory (RAM) 515. The storage 510 provides a large space for keeping static data where at least sonic instructions could be stored for later execution. According to some embodiments, such as some in-memory computing system embodiments, the RAM 515 can have sufficient storage capacity to store much of the data required for processing in the RAM 515 instead of in the storage 510. In some embodiments, the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., (OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are nut shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A method to execute a near field communication (NFC) tag based data transfer, comprising:
upon receiving a device-tap, an NFC tag initiating a communication with an associated server;
the NFC tag authenticating a corresponding NFC enabled device,
the NFC tag determining one or more notifications available at the server;
the NFC tag fetching a plurality of notifications corresponding to the NFC enabled device from the server; and
the NFC tag forwarding the plurality of notifications to the NFC enabled device.

2. The method of claim 1, further comprising:
the NFC tag persisting the plurality of notifications fetched from the server; and
upon receiving the device-tap, the NFC tag pushing the persisted plurality of notifications fetched from the server to the NFC enabled device.

3. The method of claim 1, further comprising:
at the NFC enabled device, receiving a plurality of modifications to the plurality of notifications;
upon receiving the device-tap, the NFC tag fetching the plurality of modified notifications from the NFC enabled device; and
the NFC tag establishing a communication with the associated server and forwarding the plurality of modified notifications to the associated server.

4. The method of claim 1, further comprising:
the NFC tag monitoring a status of the plurality of notifications available at the server to identify a latest version of the plurality of notifications; and
upon encountering a latest version of the plurality of notifications within a configured timeframe, the NFC tag overwriting contents of the NFC tag to match the latest version of the plurality of notifications.

5. The method of claim 4, further comprising:
the NFC tag monitoring a status of the plurality of notifications available at the server to identify a plurality of modifications to the plurality of notifications at the associated server;
upon encountering a change of the status of the plurality of notifications within a configured timeframe, the NFC tag determining the plurality of modified notifications and revising contents of the NFC tag to match the modified notifications; and
the NFC tag setting a flag to represent a revision of contents and the configured timeframe at which the revision occurred.

6. The method of claim 4, further comprising:
the NFC tag monitoring a status of the plurality of notifications available at the server to identify a latest version of the plurality of notifications;
the NFC tag scheduling a status-check at a subsequent instance when no modifications are encountered within the configured timeframe; and
the NFC tag resetting a flag to represent a no-change status of contents and the scheduled status-check at the subsequent instance.

7. The method of claim 1, further comprising: programming the NFC tag to:
determine the plurality of notifications available on the server;
fetch the plurality of notifications from the server and persist the fetched notifications on the NFC tag; and
forward the plurality of notifications from the NFC tag to the NFC enabled device.

8. The method of claim 1, further comprising: reprogramming the NFC tag to:
fetch a latest version of the plurality of notifications; and
deploy the NFC tag by the overwriting the contents of the NFC tag with latest version of the plurality of notifications.

9. An article of manufacture including a non-transitory computer readable storage medium to tangibly store instructions, which when executed by a computer, cause the computer to: program an NFC tag to
initiate a communication with an associated server, upon receiving a device-tap;
authenticate a corresponding NFC enable device;
determine one or more notifications available at the server; fetch a plurality of notifications corresponding to the NFC enabled device from the server; and
forward the plurality of notifications to the NFC enabled device.

10. The article of manufacture of claim 9, further comprising:
the NFC tag persisting the plurality of notifications fetched from the server; and
upon receiving the device-tap, the NFC tag pushing the persisted plurality of notifications fetched from the server to the NFC enabled device.

11. The article of manufacture of claim 9, further comprising:
at the NFC enabled device, receiving a plurality of modifications to the plurality of notifications;
upon receiving the device-tap, the NFC tag fetching the plurality of modified notifications from the NFC enabled device; and
the NFC tag establishing a communication with the associated server and forwarding the plurality of modified notifications to the associated server.

12. The article of manufacture of claim 9, further comprising:
the NFC tag monitoring a status of the plurality of notifications available at the server to identify a latest version of the plurality of notifications; and
upon encountering a latest version of the plurality of notifications within a configured timeframe, the NFC tag overwriting contents of the NFC tag to match the latest version of the plurality of notifications.

13. The article of manufacture of claim 12, further comprising:
the NFC tag monitoring a status of the plurality of notifications available at the server to identify a plurality of modifications to the plurality of notifications at the associated server;
upon encountering a change of the status of the plurality of notifications within a configured timeframe, the NFC tag determining the plurality of modified notifications and revising contents of the NFC tag to match the modified notifications; and
the NFC tag setting a flag to represent a revision of contents and the configured timeframe at which the revision occurred.

14. The article of manufacture of claim 12, further comprising:
the NFC tag monitoring a status of the plurality of notifications available at the server to identify a latest version of the plurality of notifications;
the NFC tag scheduling a status-check at a subsequent instance when no modifications are encountered within the configured timeframe; and
the NFC tag resetting a flag to represent a no-change status of contents and the scheduled status-check at the subsequent instance.

15. The article of manufacture of claim 9, further comprising: programming the NFC tag to:
determine the plurality of notifications available on the server;
fetch the plurality of notifications from the server and persist the fetched notifications on the NFC tag; and
forward the plurality of notifications from the NFC tag to the NFC enabled device.

16. The article of manufacture of claim 9, further comprising, further comprising:
reprogramming the NFC tag to:
fetch a latest version of the plurality of notifications; and
deploy the NFC tag by the overwriting the contents of the NFC tag with latest version of the plurality of notifications.

17. A computer system to execute a near field communication (NFC) tag based data transfer, comprising:
a processor configured to read and execute instructions stored in one or more memory elements; and
the one or more memory elements storing instructions related to
an NFC tag initialing a communication with an associated server, upon receiving a device-tap;
the NFC tag authenticating a corresponding NFC enabled device;
the NFC tag determining one or more notifications available at the server; and
the NFC tag fetching a plurality of notifications corresponding to the NFC enabled device from the server and forwarding the plurality of notifications to the NFC enabled device.

18. The computer system of claim 17 further comprising:
at the NFC enabled device, receiving a plurality of modifications to the plurality of notifications;
upon receiving the device-tap, the NFC tag fetching the plurality of modified notifications from the NFC enabled device; and
the NFC tag establishing a communication with the associated server and forwarding the plurality of modified notifications to the associated server.

19. The computer system of claim 17 further comprising:
the NFC tag monitoring a status of the plurality of notifications available at the server to identify a latest version of the plurality of notifications; and
upon encountering a latest version of the plurality of notifications within a configured timeframe, the NFC tag overwriting contents of the NFC tag to match the latest version of the plurality of notifications.

20. The computer system of claim 17 further comprising:
the NFC tag monitoring a status of the plurality of notifications available at the server to identify a plurality of modifications to the plurality of notifications at the associated server;
upon encountering a change of the status of the plurality of notifications within a configured timeframe:
the NFC tag determining the plurality of modified notifications and revising contents of the NFC tag to match the modified notifications, and
the NFC tag setting a flag to represent a revision of contents and the configured timeframe at which the revision occurred; and
when no modifications are encountered within the configured timeframe,
the NFC tag scheduling a status-check at a subsequent instance, and
the NFC tag resetting a flag to represent a no-change status of contents and the scheduled status-check at the subsequent instance.
